(19) United States
(12) Patent Application Publication
(10) Pub. No.: US 2018/0125733 A1
(43) Pub. Date: May 10, 2018

(54) Wheelchair Lifting System

(71) Applicant: Sheree L. Locher, West Seneca, NY (US)

(72) Inventor: Sheree L. Locher, West Seneca, NY (US)

(21) Appl. No.: 15/343,474

(22) Filed: Nov. 4, 2016

(51) Int. Cl. A61G 3/08

(52) U.S. Cl. CPC A61G 3/0808

(57) ABSTRACT

A wheelchair lifting system for transferring a wheelchair into and out of a vehicle includes a wheelchair that has a pair of rear wheels. A strap is provided and the strap may be manipulated. The strap is selectively extended through the spokes on each of the wheels. The strap engages the rim on each of the wheels to facilitate the wheelchair to be transferred into and out of a vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lifting devices and more particularly pertains to a new lifting device for transferring a wheelchair into and out of a vehicle.

### BRIEF SUMMARY OF THE INVENTION

An embodiment of the disclosure meets the needs presented above by generally comprising a wheelchair that has a pair of rear wheels. A strap is provided and the strap may be manipulated. The strap is selectively extended through the spokes on each of the wheels. The strap engages the rim on each of the wheels to facilitate the wheelchair to be transferred into and out of a vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a strap of a wheelchair lifting system according to an embodiment of the disclosure.

FIG. 2 is a top view of a strap of an embodiment of the disclosure.

FIG. 3 is a right side view of an embodiment of the disclosure.

FIG. 4 is a back perspective view of an embodiment of the disclosure.

FIG. 5 is a perspective in-use view of an embodiment of the disclosure.

### DETAILED DESCRIPTION OF THE INVENTION

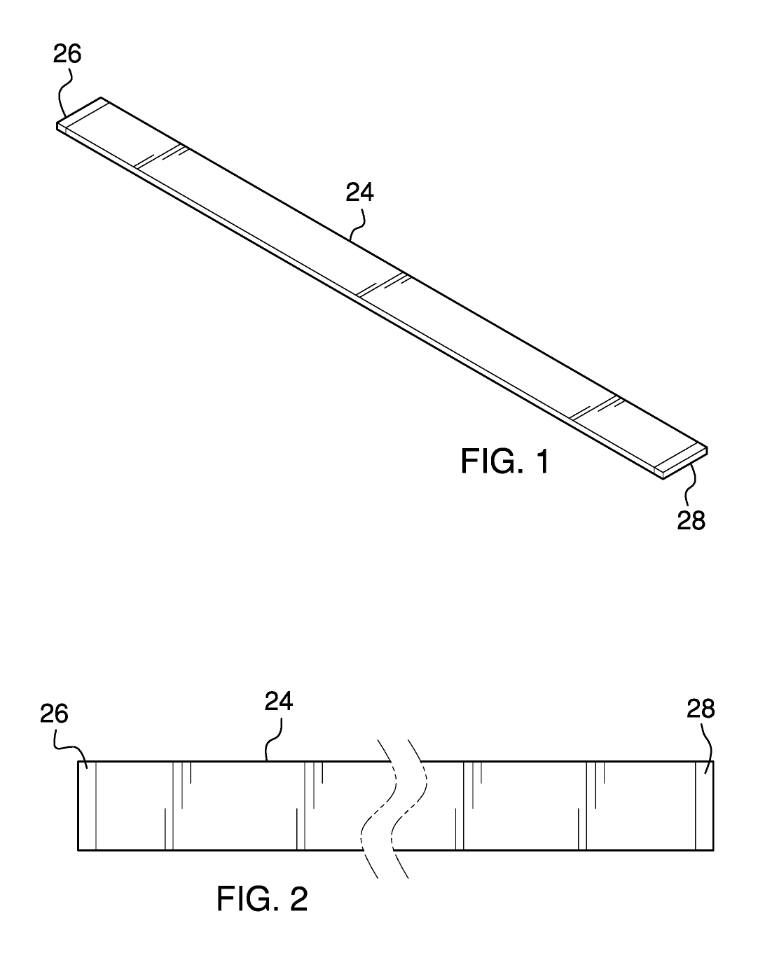

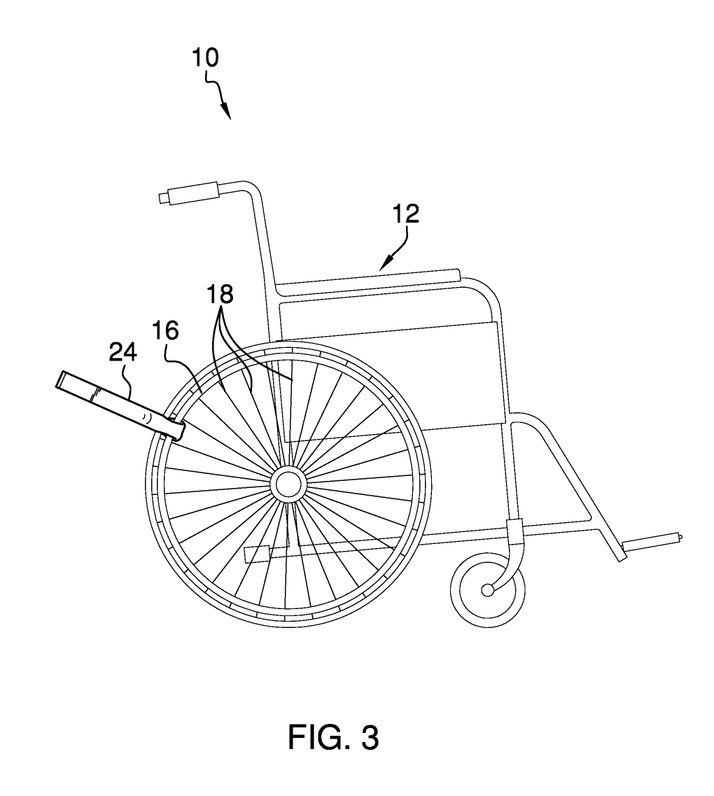

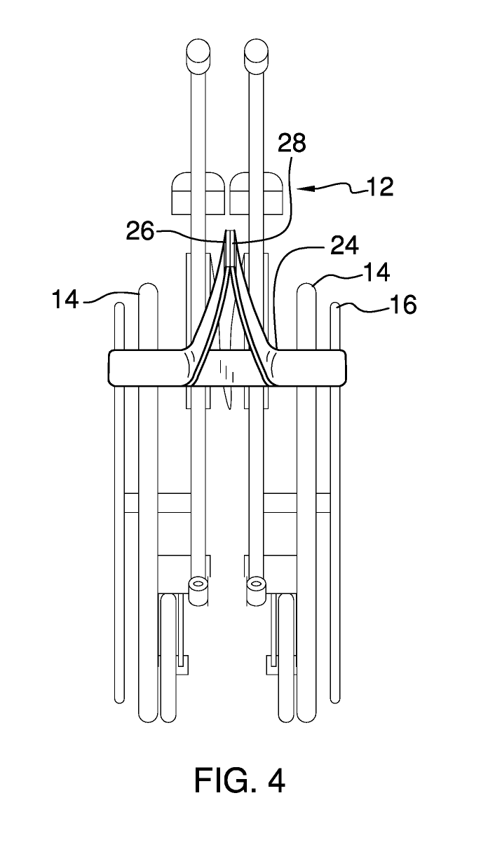

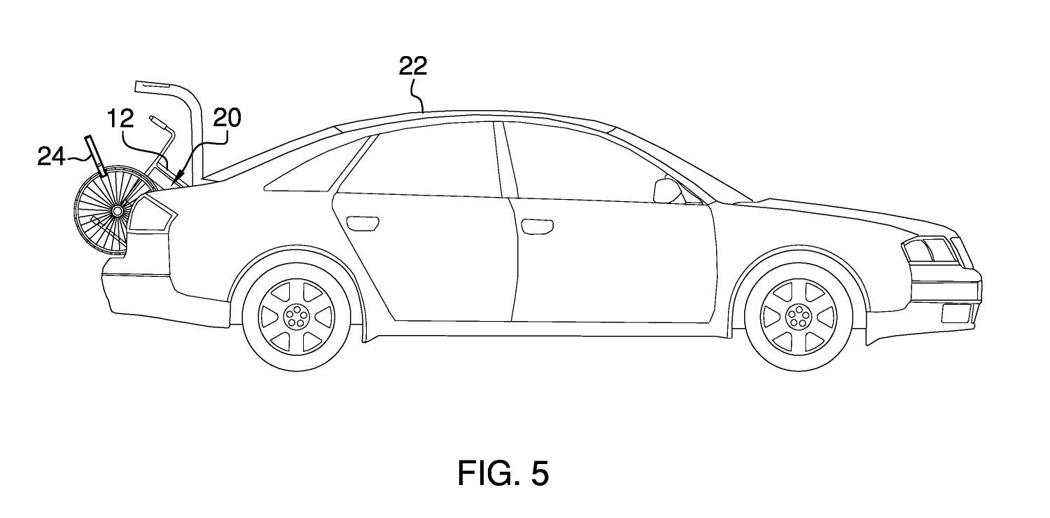

With reference now to the drawings, and in particular to FIGS. 1 through 5 thereof, a new lifting device embodying the principles and concepts of an embodiment of the disclosure and generally designated by the reference numeral 10 will be described.

As best illustrated in FIGS. 1 through 5, the wheelchair lifting system 10 generally comprises a wheelchair 12 that has a pair of rear wheels 14. Each of the rear wheels 14 includes a rim 16 and a plurality of spokes 18. The wheelchair 12 is selectively positioned in a folded position having the rear wheels 14 being aligned with each other. The wheelchair 12 may be stored in a trunk 20 of a vehicle 22 when the wheelchair 12 is in the folded position. The vehicle 22 may be a passenger vehicle or the like.

A strap 24 is provided and the strap 24 may be manipulated. The strap 24 selectively engages the wheelchair 12. Thus, the strap 24 facilitates the wheelchair 12 to be transferred into and out of the trunk 20 of the vehicle 22. The strap 24 is extended through the spokes 18 on each of the wheels. Thus, the strap 24 engages the rim 16 on each of the wheels. The strap 24 has a first end 26 and a second end 28. Each of the first end 26 and the second end 28 are gripped to lift the wheelchair 12 out of the vehicle 22.

In use, the strap 24 is extended through the spokes 18 on each of the rear wheels 14 when the wheelchair 12 is in the trunk 20 of the vehicle 22. Each of the first end 26 and the second end 28 of the strap 24 are gripped. The strap 24 engages the rim 16 on each of the rear wheels 14 when the strap 24 is lifted. Thus, the wheelchair 12 is lifted out of the trunk 20 of the vehicle 22. The strap 24 inhibits each of the rear wheels 14 from rotating when the wheelchair 12 is lifted. Thus, the strap 24 enhances stability and control of the wheelchair 12 when the wheelchair 12 is lifted. The strap 24 is extended through the spokes 18 in each of the rear wheels 14 and the wheelchair 12 is lifted into the trunk 20 of the vehicle 22 when the wheelchair is finished being used.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wheelchair lifting system comprising:
a wheelchair having a pair of rear wheels, each of said rear wheels including a rim and a plurality of spokes; and
a strap being configured to be manipulated, said strap being selectively extended through said spokes on each of said wheels such that said strap engages said rim on each of said wheels wherein said strap is configured to facilitate said wheelchair to be transferred into and out of a vehicle.

2. The system according to claim 1, wherein said wheelchair is selectively positioned in a folded position having said rear wheels being aligned with each other.

3. The system according to claim 1, wherein:
said wheelchair is selectively positioned in a folded position having said rear wheels being aligned with each other; and
said strap being extended through said spokes on each of said wheels such that said strap engages said rim on each of said wheels, said strap having a first end and a second end.

4. A wheelchair lifting system comprising:
a wheelchair having a pair of rear wheels, each of said rear wheels including a rim and a plurality of spokes, said wheelchair being selectively positioned in a folded position having said rear wheels being aligned with each other; and
a strap being configured to be manipulated, said strap selectively engaging said wheelchair wherein said strap is configured to facilitate said wheelchair to be transferred into and out of a vehicle, said strap being extended through said spokes on each of said wheels such that said strap engages said rim on each of said wheels, said strap having a first end and a second end.
